(19) United States
(12) Patent Application Publication
(10) Pub. No.: US 2026/0141477 A1
(43) Pub. Date: May 21, 2026

(54) MOBILE DEVICE AND IMAGE PROCESSING METHOD

(71) Applicant: Realtek Semiconductor Corporation, Hsinchu (TW)

(72) Inventors: Xuanming LIU, Jiangsu Province (CN); Feihu WANG, Jiangsu Province (CN); Yifan ZHANG, Jiangsu Province (CN); Hao WANG, Jiangsu Province (CN); Jiaqi YAO, Jiangsu Province (CN); Yenchun KO, Hsinchu (TW)

(21) Appl. No.: 19/380,981

(22) Filed: Nov. 6, 2025

(30) Foreign Application Priority Data
Nov. 15, 2024 (CN) 202411638672.5

(51) Int. Cl. G06T 3/4007; G06T 3/02; G06T 5/50

(52) U.S. Cl. CPC G06T 3/4007; G06T 3/02; G06T 5/50; G06T 2207/20221

(57) ABSTRACT

The present disclosure is related to a mobile device, of which an image processing circuit is electrically connected to two buses, and a processor transmits an instruction and multiple coefficients of an inverse matrix to the image processing circuit through the second bus. The instruction instructs to perform a transformation process on an input image. Based on the inverse matrix and the coordinates of an output pixel, the image processing circuit calculates the coordinates of an input pixel of the input image, thereby reading the input pixel from a memory through the first bus. The image processing circuit also writes the output pixel to the memory through the first bus.

### RELATED APPLICATIONS

This application claims priority to China Application Serial Number 202411638672.5, filed Nov. 15, 2024, which is herein incorporated by reference in its entirety.

### BACKGROUND

### Technical Field

The present disclosure relates to an image processing method applicable to a mobile device.

### Description of Related Art

Mobile devices (such as mobile phones, smart watches, and smart bracelets) are usually equipped with a display panel. In order to present a user interface, it is necessary to frequently perform some image processing processes (such as a perspective transformation and an affine transformation) on the images. These transformations consume the computational resources when being processed, thereby affecting the power consumption, which is especially critical for a mobile device with a limited battery capacity. In some conventional technologies, the abovementioned image processing process is performed by a graphics processing unit, but this consumes more power consumption.

### SUMMARY

Embodiments of the present disclosure provide a mobile device which includes a processor, a first bus, a memory, a bridge, a second bus, a display controller, and an image processing circuit. The first bus is electrically connected to the processor. The memory is electrically connected to the first bus. A first terminal of the bridge is electrically connected to the first bus. The second bus is electrically connected to a second terminal of the bridge. A bandwidth of the second bus is less than a bandwidth of the first bus. The display controller is electrically connected to the second bus. The image processing circuit is electrically connected to the first bus and the second bus. The processor sends the instruction and plural coefficients of an inverse matrix of a transformation matrix to the image processing circuit through the first bus, the bridge, and the second bus. The instruction instructs to perform a transformation process on an input image. The image processing process includes a geometric transformation process and a blending process. Upon receiving the instruction, the image processing circuit calculates a coordinate of an input pixel of the input image based on the coefficients and a coordinate of an output pixel, thereby reading the input pixel from the memory through the first bus. The image processing circuit is configured to write the output pixel into the memory through the first bus.

In some embodiments, for the coordinate of the output pixel, the number of the at least one input pixel is 4, and the image processing circuit is further configured to perform a bi-linear interpolation on the input pixel to calculate an equivalent input pixel.

In some embodiments, after generating an output image, the image processing circuit automatically generates a next output image through a contiguous mode, an auto-reload mode, or a linked list mode.

In some embodiments, the transformation process includes a perspective transformation or an affine transformation, and the image processing circuit is configured to multiply the coordinate of the output pixel by the inverse matrix and then divide by a preset value to obtain the coordinate of the input pixel.

In some embodiments, the number of the at least one input image is greater than 1, and the image processing circuit is configured to perform a blending process on the at least one input image.

In some embodiments, the first bus is an Advanced extensible Interface (AXI), and the second bus is an Advanced Peripheral Bus (APB).

In some embodiments, the image processing circuit includes the following elements. A first port is connected to the first bus. A second port is connected to the second bus. A global register is connected to the second port. A writing image layer register is connected to the second port. A writing circuit is connected to the writing image layer register and the first port. The image processing circuit further includes plural image layer processors. Each image layer processor includes: a reading image layer register connected to the second port; a coordinate computing circuit configured to calculate the coordinate of the input pixel; a reading circuit configured to control plural direct memory access (DMA) channels; an input buffer connected to the first port and configured to store the input pixel; a computing circuit connected to the input buffer; and an interpolation circuit connected to the computing circuit. The image processing circuit further includes: a blending circuit connect to the interpolation circuit; a pixel format converter connected to the blending circuit; and an output buffer connected to the first port.

In some embodiments, the number of the at least one input image is greater than 1, the blending circuit includes plural blenders, and each plural blender is configured to receive two of the at least one input image and perform a blending process.

In some embodiments, the input buffer and the output buffer have a first-in-first-out (FIFO) mechanism.

In some embodiments, the processor is further configured to send a suspension instruction, a resumption instruction, or an abortion instruction to the image processing circuit through the first bus, the bridge, and the second bus.

In some embodiments, the mobile device further includes an external device that is electrically connected to the image processing circuit. The image processing circuit communicates with the external device based on a DMA handshake.

In another aspect, embodiments of the present disclosure provides an image processing method that is applicable to an image processing circuit of a mobile device and includes: receiving an instruction and plural coefficients of an inverse matrix of a transformation matrix from a processor through a second bus; upon receiving the instruction, calculating a coordinate of an input pixel of an input image based on the coefficients and a coordinate of an output pixel, thereby reading the input pixel from a memory through a first bus; and writing the output pixel into the memory through the first bus.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram showing the architecture of a mobile device according to one embodiment.

FIG. 2 is a schematic diagram illustrating a coordinate and a bi-linear interpolation after transformation according to one embodiment.

FIG. 3 is a schematic diagram illustrating a blending process according to one embodiment.

FIG. 4 is a schematic diagram showing the internal structure of an image processing circuit according to one embodiment.

FIG. 5 is a flow chart illustrating an image processing method according to one embodiment.

### DETAILED DESCRIPTION

Specific embodiments of the present disclosure are further described in detail below with reference to the accompanying drawings. However, the embodiments described are not intended to limit the present disclosure and it is not intended for the description of operations to limit the order of implementation.

The terms “first” and “second” used in the specification should be understood as identifying units or data described by the same terminology, and do not refer to a particular order or sequence. In the present disclosure, when describing that two elements are electrically connected to each other, other element(s) (such as a bridge, a resistor, and a switch) may be disposed between these two elements.

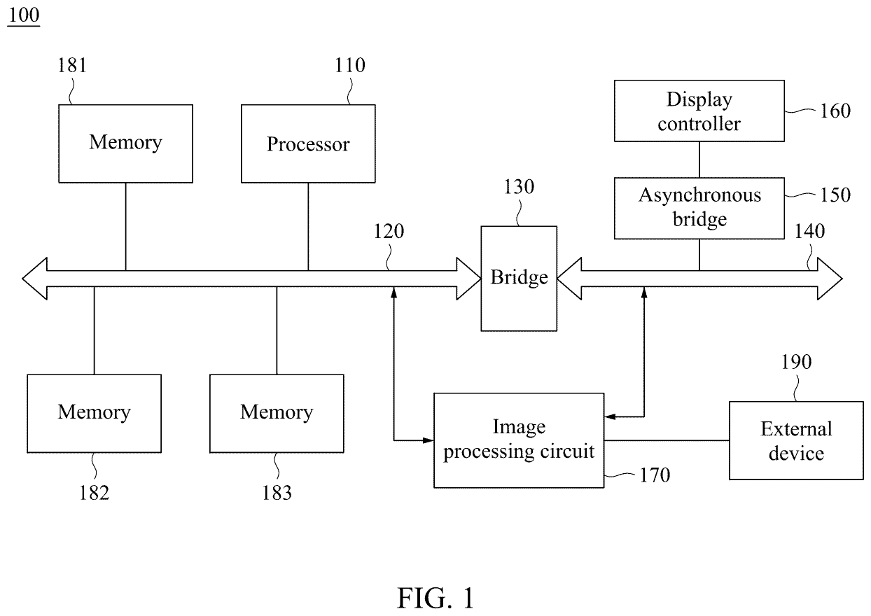

FIG. 1 is a schematic diagram showing the architecture of a mobile device 100 according to one embodiment. Referring to FIG. 1, the mobile device 100 is, for example, a smart watch, a smart bracelet, a mobile phone, or other mobile device. The mobile device 100 includes a processor 110, a first bus 120, a bridge 130, a second bus 140, an asynchronous bridge 150, a display controller 160, an image processing circuit 170, and memories 181-183.

The processor 110 is, for example, a central processing unit (CPU) or a microprocessor, and is electrically connected to the first bus 120. The memories 181-183 are also electrically connected to the first bus 120. In this embodiment, the memories 181-183 belong to different types. For example, the memory 181 is a static random access memory (SRAM), the memory 182 is a flash memory (Flash), and the memory 183 is a pseudo SRAM, but the present disclosure is not limited thereto. The memories 181-183 store input images to be processed, and the processed images may also be stored in the memories 181-183.

The first bus 120 is electrically connected to a first terminal of the bridge 130, and the second bus 140 is electrically connected to a second terminal of the bridge 130. The bridge 130 transmits data on the first terminal (or the second terminal) to the second terminal (or the first terminal). In this embodiment, the bandwidth of the second bus 140 is less than the bandwidth of the first bus 120. For example, the first bus 120 is an Advanced extensible Interface (AXI), and the second bus 140 is an advanced peripheral bus (APB), but the present disclosure is not limited thereto. The asynchronous bridge 150 is electrically connected to the second bus 140, and the display controller 160 is electrically connected to the asynchronous bridge 150. The display controller 160 may be further electrically connected to a display (not shown). Since the clock or timing (e.g., the frame rate) of the display controller 160 is different from the clock or timing of the second bus 140, the asynchronous bridge 150 is required for data transmission.

The image processing circuit 170 is electrically connected to the first bus 120 and the second bus 140 and is configured to perform a transformation process on the input images stored in the memories 181-183. The transformation process may include a perspective transformation or an affine transformation. In specific, the transformation process may be expressed by Mathematical Formula 1 as follows:

$$M \times X = Y , \qquad [ Mathematical Formula 1 ]$$

where X represents a coordinate of one pixel of the input image including three numerical values of an X coordinate, a Y coordinate, and a homogeneous coordinate, M is a 3×3 transformation matrix, and Y is a coordinate of the corresponding pixel of the output image similarly including an X coordinate, a Y coordinate, and a homogeneous coordinate. The perspective transformation and the affine transformation can be achieved by setting the coefficients of the transformation matrix. In this embodiment, the coordinate of the input pixel is inversely derived from the coordinate of the output pixel, as shown in Mathematical Formula 2 as follows:

$$X = {M}^{- 1} \times Y , \qquad [ Mathematical Formula 2 ]$$

where M⁻¹ represents the inverse matrix (the size is also 3×3) of the transformation matrix M. The coefficients of the inverse matrix M⁻¹ is provided by the processor 110. The processor 110 sends an instruction and the coefficients of the inverse matrix M⁻¹ to the image processing circuit 170 through the first bus 120, the bridge 130, and the second bus 140 in sequence, in which the instruction is used for instructing to perform a transformation process on the input image. After receiving the instruction, the image processing circuit 170 calculates the coordinates X of the input pixels in the input image according to the coefficients of the inverse matrix M⁻¹ and the coordinate Y of the output pixels. After obtaining the coordinates X, the image processing circuit 170 reads the input pixels from the memories 181-183 through the first bus 120. After completing the transformation process, the image processing circuit 170 is configured to write the output pixels (which form an output image) into the memories 181-183 through the first bus 120.

Because the coefficients of the inverse matrix M⁻¹ may possibly be floating numbers, in order to reduce the amount of calculation of the image processing circuit 170, the processor 110 may multiply the coefficients by a preset value (e.g., 65536, but the present disclosure is not limited thereto), in order to represent all coefficients by integers. Therefore, after multiplying the coordinates of the output pixels by the inverse matrix, the image processing circuit 170 requires to divide by the preset value for obtaining the coordinate of the input pixel. In some embodiments, any complement may also be used to represent a negative value.

In some embodiments, the image processing circuit 170 may be served as a circuit module that is integrated into a system on a chip (SOC). In comparison with the conventional technology in which the transformation process is performed by a graphics processing unit (GPU), the image processing circuit 170 has the advantages of low cost and small size. For example, the conventional technology is to use the memory in the GPU to temporarily store the input image, but this method requires more memory space and even results in memory space deficiency. On the contrary, in this embodiment, the image processing circuit 170 does not need such a large memory space to store the entire input image (or multiple input images); the coordinates of the input pixels are first inferred from the coordinates of the output pixels, and then the required input pixels are read from the memories 181-183. These image processing processes can save memory costs. In addition, the image processing circuit 170 is electrically connected to the first bus 120 and the second bus 140 of different bandwidths, in which the second bus 140 with a lower bandwidth is used to transmit the instruction, while the first bus 120 with a higher bandwidth is used to transmit the image. Such allocation can improve the overall efficiency.

In some embodiments, the image processing circuit 170 is further electrically connected to an external device 190. The image processing circuit 170 communicates with the external device 190 based on a direct memory access (DMA) handshake, thereby reading the input image or writing the output image into the external device 190. The external device 190 may be, for example, a memory card, a portable hard disk, or any storage apparatus. In the DMA handshake mode, each data transmission has to ensure that the external device 190 is ready. This method may synchronize data transmissions and the status of the external device 190 better. In addition, this mode may also provide better data transmission efficiency, especially for image or video related application scenarios.

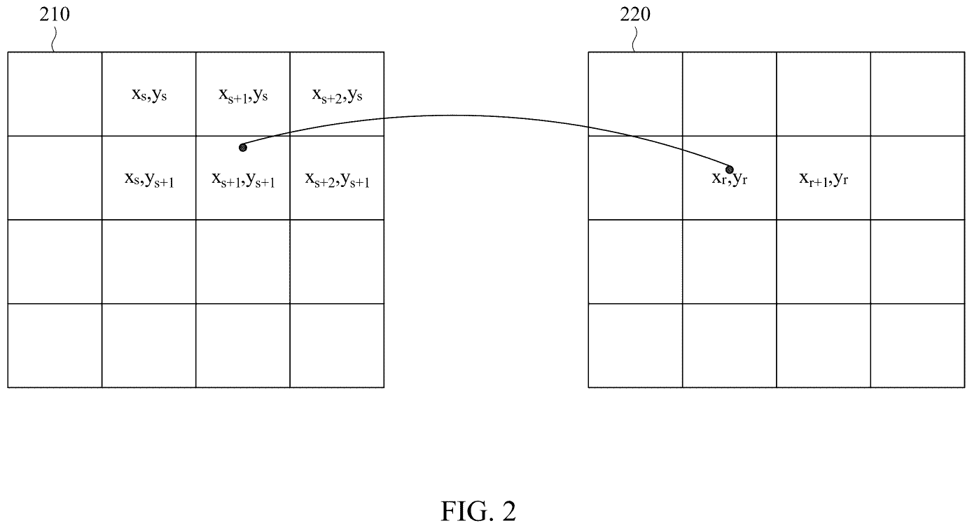

FIG. 2. is a schematic diagram illustrating a coordinate and a bi-linear interpolation after transformation according to one embodiment. Referring to FIG. 2, a transformation process is performed on an input image 210 to generate an output image 220. In such a case, the coordinate of the input pixel is (xᵣ, yᵣ). After the above calculation, the coordinate corresponding to the input pixel is probably not an integer, and thus four nearest input pixels are found, of which the coordinates are (xₛ, yₛ), (xₛ₊₁, yₛ), (xₛ, yₛ₊₁), and (xₛ₊₁, yₛ₊₁), respectively. The grayscale value of an equivalent input pixel can be obtained by performing a bi-linear interpolation on the four input pixels, and such equivalent input pixel will also be used in the abovementioned transformation process.

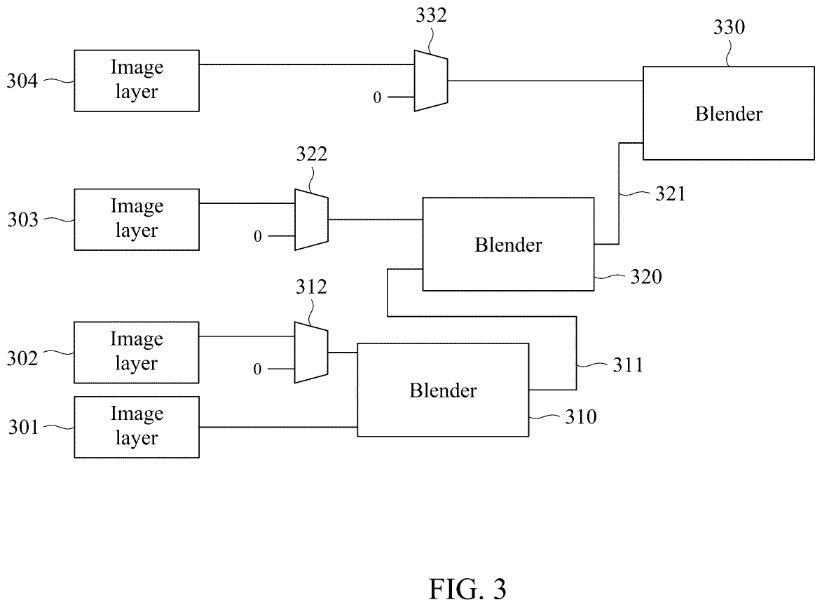

The image processing circuit 170 also supports alpha masking, and can pre-process the alpha of each input pixel. For example, for the input pixel with a grayscale value Aₘ, a calculation of Aₘ×A_{c}/255 may be performed, where A_{c} is an alpha. The alpha is also served as a weight to calculate the weighted sum of the grayscale values of the two input images during the blending process. FIG. 3 is a schematic diagram illustrating a blending process according to one embodiment. Referring to FIG. 3, the image processing circuit 170 includes plural blenders 310, 320, and 330. Here, four input images are represented as image layers 301-304. The four image layers 301-304 may undergo the abovementioned transformation process first and then may be blended. The first input and the second input of the blender 310 are the image layer 301 and the image layer 302, respectively. The output 311 of the blender 310 is served as one input of the blender 320, and the other input of the blender 320 is the image layer 303. The output 321 of the blender 320 is served as one input of the blender 330, and the other input of the blender 330 is the image layer 304. Two image layers inputted into the blender are considered as a foreground and a background, respectively. The operation of a single blender can be expressed by Mathematical Formula 3 as follows:

$${C}_{R} = \frac{{{C}_{FG}}^{*} {A}_{FG} + {{C}_{BG}}^{*} ( 255 - {A}_{FG} )}{255} ; \qquad [ Mathematical Formula 3 ]$$

$${A}_{R} = \frac{{{A}_{FG}}^{*} {A}_{FG} + {{A}_{BG}}^{*} ( 255 - {A}_{FG} )}{255} ,$$

where C_{FG} represents the color component (such as the grayscale value of red, green or blue) of the foreground, C_{BG} represents the color component (such as the grayscale value of red, green or blue) of the background, A_{FG} represents the alpha of the foreground, A_{BG} is the alpha of the background, CR is the color component outputted by the blender, and A_{R} is the alpha outputted by the blender.

In addition, the multiplexers 312, 322, 332 are configured to determine whether to user the numeric “0” in blending. For example, the multiplexer 312 may select the numeric “0” as the input of the blender 310, and as such the grayscale value C_{BG} in Mathematical Formula 3 is set to be 0.

In some embodiments, the input of the blender 310, 320, or 330 may also be a pure color image. For example, the processor 110 specifies a pure color grayscale value, and each pixel in the pure color image has a pure color grayscale value. Assuming that the image layer 302 is a pure color image, the blender 310 performs blending on the input image (i.e., the image layer 301) and the pure color image. In such a case, the image processing circuit 170 does not need to read the pure color image from the memories 181-183, and only needs to replace the grayscale value C_{FG} or C_{BG} in Mathematical Formula 3 with the pure color grayscale value, which is equivalent to performing the blending process on the input image and the pure color image. In other embodiments, the image processing circuit 170 may also have more than two blenders, but the present disclosure is not limited thereto.

The image processing circuit 170 may adopt the RGB format for input and output and also support various RGB modes, such as the RGB565 mode and the RGB888 mode, or may also support the A8 format. In other embodiments, the image processing circuit 170 may also adopt another color format, such as the YUV format. The image processing circuit 170 may also perform a format conversion on the input image or the output image. The image processing circuit 170 may also support a color key, which is capable of changing a setting grayscale value (also referred to as a key) of the input image into a preset grayscale value (e.g., 0). In other words, all pixels of the input image that have the same value with the key are changed to be 0. In some embodiments, the color key may also be a range, i.e., the grayscale values in a certain range are all changed into the preset grayscale value.

The image processing circuit 170 also provides a multi-frame mechanism, which may adopt a contiguous mode, an auto-reload mode, or a linked list mode. After the image processing circuit 170 generates an output image, the next output image can be automatically processed (e.g., generated) through one of the above modes. For example, when the linked list mode is adopted, the processor 110 transmits a list to the image processing circuit 170. This list records plural nodes, and each node includes a starting point of the frame and a pointer to the next node. Those with ordinary knowledge in the art should understand the above-mentioned modes, and are not described here. In this way, the processor 110 does not need to send the corresponding instruction for each frame, and the image processing circuit 170 will automatically perform the image processing processes for multiple frames.

The image processing circuit 170 may support secure accesses and non-secure accesses. The image processing circuit 170 may also support operation of suspending, resuming, or aborting during the process, i.e., the processor 110 may also send a suspension instruction, a resumption instruction, and an abortion instruction to the image processing circuit 170 through the first bus 120, the bridge 130, and the second bus 140.

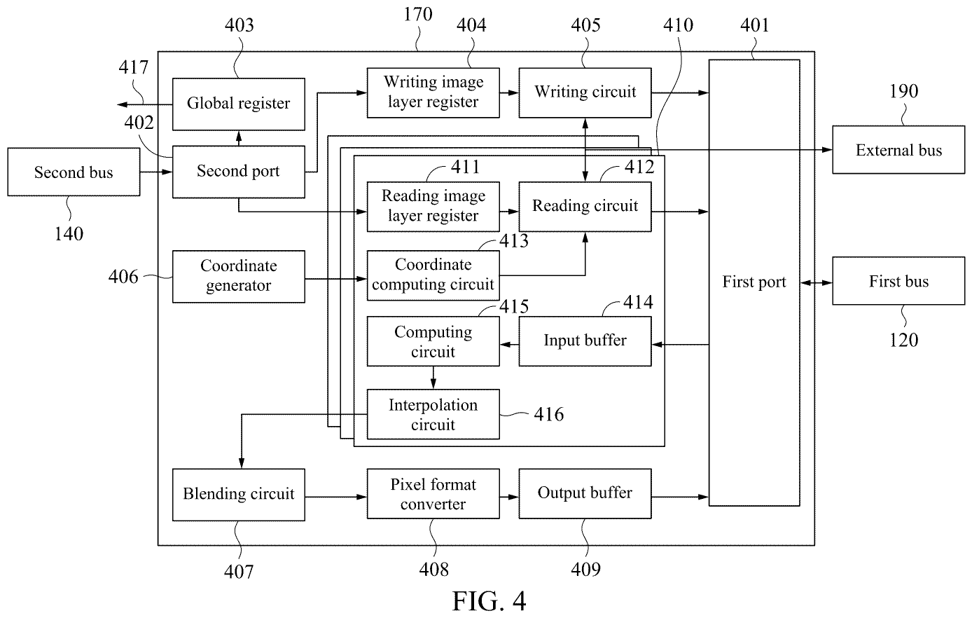

FIG. 4 is a schematic diagram showing the internal structure of the image processing circuit 170 according to one embodiment. Referring to FIGS. 1 and 4, the image processing circuit 170 includes a first port 401, a second port 402, a global register 403, a writing image layer register 404, a writing circuit 405, a coordinate generator 406, a blending circuit 407, a pixel format converter 408, an output buffer 409, and image layer processors 410. Each image layer processor 410 includes a reading image layer register 411, a reading circuit 412, a coordinate computing circuit 413, an input buffer 414, a computing circuit 415, and an interpolation circuit 416.

The first port 401 is connected to the first bus 120, and the second port 402 is connected to the second bus 140. For example, the first port 401 complies with the specification of the AXI bus, and the second port 402 complies with the specification of the APB bus. It is worth noting that the positions of the first bus 120 and the second bus 140 in FIG. 4 are different from those in FIG. 1, but this does not affect the following description.

The global register 403 is connected to the second port 402 for storing global information. For example, the global information includes information that the processor 110 sends the suspension instruction, the resumption instruction, or the abortion instruction. The global information may also include information on whether to perform the contiguous mode, the auto-reload mode, or the linked list mode. In some embodiments, the image processing circuit 170 further receives/transmits a signal 417 representing an interruption. For example, the interruption may be sent after an image is processed.

The writing image layer register 404 is connected to the second port 402 and is configured to store information related to the input image, such as the size and position of the input image. The writing circuit 405 is connected to the writing image layer register 404 and the first port 401 and is configured to convert the position information of the output image into a DMA channel and then write the output pixel (the output image) into the memories 181-183 through the first port 401 and the first bus 120.

The reading image layer register 411 is connected to the second port 402 and is configured to store information related to the input image, such as the size and the position of the input image, the starting position of the image layer when performing the blending process, the alpha, the setting grayscale value, the pure color grayscale value and the coefficients of the inverse matrix. In some embodiments, each image layer has its corresponding inverse matrix coefficients. The coordinate generator 406 is configured to generate the coordinates of the output pixels, e.g., generating the coordinate from left to right and then from up to bottom in the output image. The coordinate computing circuit 413 is configured to calculate the coordinate of the required input pixels according to the coordinates of the output pixels and the coefficients of the inverse matrix. This step has been described above in detail and is not repeatedly described herein. The reading circuit 412 is connected to the reading image layer register 411 and is configured to convert the position information of the input pixels into DMA channels and then read the input pixels from the memories 181-183 through the first port 401 and the first bus 120.

The input buffer 414 is connected to the first port 401, and input pixels read by the reading circuit 412 are stored in the input buffer 414. The computing circuit 415 is connected to the input buffer 414 and is configured to perform pixel formal conversion and color key. The interpolation circuit 416 is connected to the computing circuit 415 and is configured to perform a bi-linear interpolation, of which the related operations have been described above.

Each image layer processor 410 is configured to process a single image layer, and the interpolation circuits 416 of the image layer processors 410 are connected to the blending circuit 407. The blending circuit 407 includes plural blenders for performing blending processes, of which the related operations have been described above. For example, each blender is configured to receive two of the input images and perform a blending process. The pixel format converter 408 is connected to the blending circuit 407 and is configured to perform a pixel format conversion, and the converted output pixels are stored in the output buffer 409. The output buffer 409 is connected to the first port 401 and writes the output pixels into the corresponding memories 181-183 by the control of the writing circuit 405. In some embodiments, the input buffer 414 and the output buffer 409 have a first-in-first-out (FIFO) mechanism.

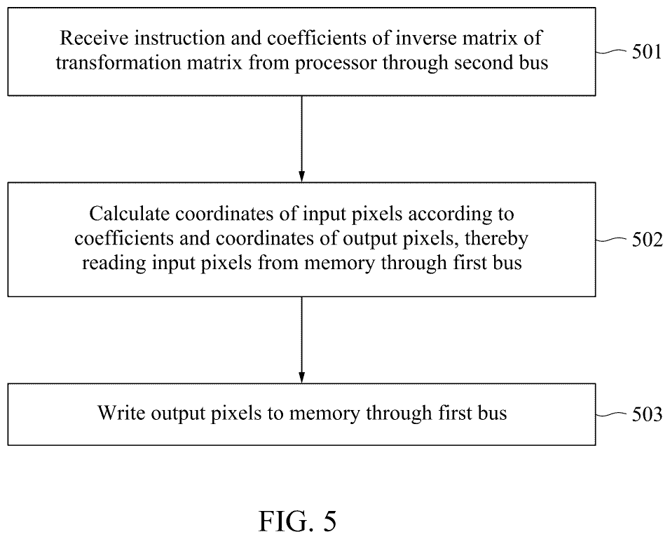

FIG. 5 is a flowchart illustrating an image processing method according to one embodiment. The image processing method is performed by the image processing circuit 170. At Step 501, an instruction and coefficients of an inverse matrix of a transformation matrix from the processor 110 are received through the second bus 140. At Step 502, coordinates of input pixels are calculated according to the coefficients and coordinates of the output pixels, thereby reading the input pixels from a memory through the first bus 120. At Step 503, the output pixels are written to the memory through the first bus 120. The Steps in FIG. 5 have been described in detail above and will not be repeated here. It should be noted that each step in FIG. 5 can be implemented as plural program codes or plural circuits, and the present disclosure is not limited thereto. In addition, the image processing method of FIG. 5 can be used in conjunction with the above embodiments or can be used alone. In other words, other step(s) can be added between adjacent two of the steps of FIG. 5.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure.

What is claimed is:

1. A mobile device, comprising:
a processor;
a first bus electrically connected to the processor;
a memory electrically connected to the first bus;
a bridge of which a first terminal is electrically connected to the first bus;
a second bus electrically connected to a second terminal of the bridge, wherein a bandwidth of the second bus is less than a bandwidth of the first bus;
a display controller electrically connected to the second bus; and
an image processing circuit electrically connected to the first bus and the second bus;
wherein the processor is configured to send an instruction and a plurality of coefficients of an inverse matrix of a transformation matrix to the image processing circuit through the first bus, the bridge, and the second bus, wherein the instruction instructs to perform a transformation process on at least one input image;
wherein upon receiving the instruction, the image processing circuit is configured to calculate a coordinate of at least one input pixel of the at least one input image based on a coordinate of an output pixel and the plurality of coefficients, thereby reading the at least one input pixel from the memory through the first bus;
wherein the image processing circuit is configured to write the output pixel into the memory through the first bus.

2. The mobile device of claim 1, wherein for the coordinate of the output pixel, a number of the at least one input pixel is 4, and the image processing circuit is further configured to perform a bi-linear interpolation on the at least one input pixel to calculate an equivalent input pixel.

3. The mobile device of claim 1, wherein after generating an output image, the image processing circuit automatically generates a next output image through a contiguous mode, an auto-reload mode, or a linked list mode.

4. The mobile device of claim 1, wherein the transformation process comprises a perspective transformation or an affine transformation, and the image processing circuit is configured to multiply the coordinate of the output pixel by the inverse matrix and then divide by a preset value to obtain the coordinate of the at least one input pixel.

5. The mobile device of claim 1, wherein a number of the at least one input image is greater than 1, and the image processing circuit is configured to perform a blending process on the at least one input image.

6. The mobile device of claim 1, wherein the first bus is an Advanced extensible Interface (AXI), and the second bus is an Advanced Peripheral Bus (APB).

7. The mobile device of claim 1, wherein the image processing circuit comprises:
a first port connected to the first bus;
a second port connected to the second bus;
a global register connected to the second port;
a writing image layer register connected to the second port;
a writing circuit connected to the writing image layer register and the first port;
a plurality of image layer processors, each comprising:
a reading image layer register connected to the second port;
a coordinate computing circuit configured to calculate the coordinate of the at least one input pixel;
a reading circuit configured to control a plurality of direct memory access (DMA) channels;
an input buffer connected to the first port and configured to store the at least one input pixel;
a computing circuit connected to the input buffer; and
an interpolation circuit connected to the computing circuit;
a blending circuit connect to the interpolation circuit;
a pixel format converter connected to the blending circuit; and
an output buffer connected to the first port.

8. The mobile device of claim 7, wherein a number of the at least one input image is greater than 1, the blending circuit comprises a plurality of blenders, and each of the plurality of blenders is configured to receive two of the at least one input image and perform a blending process.

9. The mobile device of claim 7, wherein the input buffer and the output buffer have a first-in-first-out (FIFO) mechanism.

10. The mobile device of claim 1, wherein the processor is further configured to send a suspension instruction, a resumption instruction, or an abortion instruction to the image processing circuit through the first bus, the bridge, and the second bus.

11. The mobile device of claim 1, further comprising:
an external device electrically connected to the image processing circuit, wherein the image processing circuit communicates with the external device based on a DMA handshake.

12. An image processing method applicable to an image processing circuit of a mobile device, the image processing method comprising:
receiving an instruction and a plurality of coefficients of an inverse matrix of a transformation matrix from a processor through a second bus, wherein the processor is electrically connected to a first bus, the first bus is electrically connected to a first terminal of a bridge, a second terminal of the bridge is electrically connected to the second bus, a memory is electrically connected to the first bus, a bandwidth of the second bus is less than a bandwidth of the first bus, and the instruction is used for instructing to perform a transformation process on at least one input image;
upon receiving the instruction, calculating a coordinate of at least one input pixel of the at least one input image based on the plurality of coefficients and a coordinate of an output pixel, thereby reading the at least one input pixel from the memory through the first bus; and
writing the output pixel into the memory through the first bus.

13. The image processing method of claim 12, wherein a number of the at least one input pixel is 4, and the image processing method further comprises:
performing a bi-linear interpolation on the at least one input pixel to calculate an equivalent input pixel.

14. The image processing method of claim 12, further comprising:
after generating an output image, automatically generating a next output image through a contiguous mode, an auto-reload mode, or a linked list mode.

15. The image processing method of claim 12, wherein the transformation process comprises a perspective transformation or an affine transformation, and the image processing method further comprises:
multiplying the coordinate of the output pixel by the inverse matrix, and then dividing by a preset value to obtain the coordinate of the at least one input pixel.

16. The image processing method of claim 12, wherein a number of the at least one input image is greater than 1, and the image processing method further comprises:
performing a blending process on the at least one input image.

17. The image processing method of claim 12, wherein the first bus is an Advanced extensible Interface (AXI), and the second bus is an Advanced Peripheral Bus (APB).

18. The image processing method of claim 12, further comprising:
receiving a suspension instruction, a resumption instruction, or an abortion instruction from the processor through the second bus.
